(19) United States
(12) Patent Application Publication
(10) Pub. No.: US 2004/0237036 A1
(43) Pub. Date: Nov. 25, 2004

(54) Methods and systems for generating supporting files for commands

(76) Inventors: Robert D. Qulst, Loveland, CO (US); Lawrence R. Rowland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/443,594

(22) Filed: May 21, 2003

(51) Int. Cl. G06F 15/00

(52) U.S. Cl. 715/513

(57) ABSTRACT

A method for generating supporting documents for command code in a command line oriented operating environment is disclosed. The method includes creating an XML source file, the XML source file including information required for generating parser code. The parser code facilitates compiling the command code. The method further includes generating at least two of a man page file, a usage message file, and the parser code from the XML source file.

### BACKGROUND OF THE INVENTION

With the widespread use of computers and associated technologies, there is a continual need to update the programs that execute on various computer systems. Frequent updates are needed to provide compatibility, added functionality, and/or bug fixes, for example. With each update, there are typically instructions to the user reflecting the new features and/or bug fixes for the updated program.

In a command line oriented operating environment (e.g. UNIX, LINUX and DOS), for example, a software upgrade can include new command sets, new options to existing commands, the deletion of previous commands, and the like. To assist the user in utilizing the updated software, hundreds of manual pages (manpages) may be furnished. A manpage may provide, for example, a description of a command, the syntax of using the command, and various options associated with the command. Accordingly, the accuracy of the manpages is crucial to a user's ability to leverage the command sets and to maintain productivity, particularly after a software upgrade.

Up to now, however, the process of creating manpages has been fairly labor intensive and error-prone. Generally speaking, the commands and the manpages have been treated as two separate projects, often staffed by different groups of human engineers. Due to the problems associated with coordination, communication, and/or due to simple human interpretation errors, changes that are made to the commands by one group of engineers sometimes do not result in updates to the appropriate manpages by the engineers responsible for updating the manpages.

Furthermore, the typical approach for developing manpages is to use NROFF, which is a language that describes how the manpages will look when the manpage components are coded. Invoked by a “man” command (e.g. UNIX), the manpage component is processed and the online manual page corresponding to the command is displayed. However, NROFF is an inflexible and difficult-to-use language that is at least 20 years old. The only way to validate an NROFF file is to run the file and view the result on a display to determine if it is valid. Without the ability to perform document verification, manpages creators must resort to time-consuming sample executions of the NROFF files and to visually determine whether there are errors in the NROFF codes by viewing the execution result.

FIG. 1 shows a prior art flow diagram illustrating the process for creating commands and associated manpages. The left half of the flow diagram represents the exemplary actions taken by as well as the work products outputted by development engineers, who are responsible for creating and/or modifying the commands. The right half of the flow diagram represents the exemplary actions taken by as well as the work products outputted by learning products engineers, who are responsible for ensuring that the manpages reflect the commands created by the development engineers.

The flow diagram begins with the external specification in block 102. Generally speaking, the external specification is a document outlining the product features, typically in response to marketing requirements. The external specification is employed by learning products engineers to develop a learning products plan (104). The output is a learning products plan (106), including the schedule that outlines various milestones and deliverables for which the learning products engineers are responsible.

The external specification (102) is also employed by the development engineers to develop code (108) that implements the external specification. In block 110, the development engineers draft manpages associated with the coded commands, which were created in accordance with the external specification. Since the development engineers have intimate knowledge of the commands created, the manpage drafts are therefore typically created by the development engineers, at least initially. The creation of the preliminary manpages at this stage may be performed by the development engineers alone, or may be performed with the assistance of the learning products engineers.

A preliminary manpage document is thus produced (112). In block 114, the learning products engineers review the preliminary manpage document, e.g., for proper grammar and English, and in some instances will encode the manpage in NROFF. Since the documents furnished by the development engineers are typically in a word processing file format (e.g., Word by Microsoft Corporation of Redmond, Wash.), ASCII, or another human-readable format, the learning products engineers need to interpret the information furnished and attempt to create in NROFF manpages that reflect what the development engineers intend. As is typical in the case where human interpretation and human communication are involved between groups of people, errors are often inadvertently introduced, creating potential logical disconnects between the commands and the resultant manpages. Additionally, formatting that is sometimes available in one file format (e.g., the aforementioned Word processing application) may not available in NROFF.

Even if the learning products engineers can somehow interpret the intent of the development engineers with 100% accuracy, the resultant manpages may still vary considerably in style, format, and order. This is because different learning product engineers may code the manpages differently, based on individual, subjective NROFF coding practices and preferences. Thus, different manpages in the same product may look different and/or be organized differently, rendering the manpages more difficult to read and understand than necessary for users.

In block 116, the development engineers continue code development to fine tune the commands, to fix bugs, and sometimes to add new functionalities. For each change made to a command, a development engineer has the option to notify the learning products engineers of the change so that the learning products engineers can reflect the change in the appropriate manpage(s). Some development engineers are diligent at notifying learning product engineers of all changes. Other development engineers simply forget or do not bother to inform the learning products engineers of the changes in the commands, thereby rendering the manpages unsynchronized with the changed commands. Other product engineers, by exercising their discretion in block 118, may decide that some changes are not worth getting reflected in the manpages. Inevitably, some of these subjective decisions are wrong, and some manpages would become unsynchronized with the changed commands as a result.

In block 114, the review/edit cycles for the manpages take place. At some point, it is necessary to move toward publication (122), which results in the final manpage work product (124). In some cases, changes to the commands that occur late in the development cycle may fail to get updated in the manpages since the publication process (122) has already begun. For these commands, the manpages therefor would remain unsynchronized until the next release of the manpages.

The manual and time-consuming process involved in generating manpages may, in some cases, cause manpages to be unsynchronized with the released code. FIG. 2 illustrates a prior art example of how inconsistency between the released code and the manpage can arise for a product. A product is initially released with version 1.0 code 202 and version 1.0 manpage 204. Later, version 2.0 code 206 and version 2.0 manpage 208 are released. Up to now, each code release has a corresponding manpage release. However, when version 3.0 code 210 is released, there is not a corresponding 3.0 manpage release to reflect the code changes because there may not have been sufficient resources, e.g., time or engineering resources, to revise the manpages. Instead, version 2.0 manpage 208 is released with code version 3.0 210. Consequently, new commands created and/or modified in version 3.0 may not be known to the users and/or old commands that are no longer supported in version 3.0 may still be discussed in the manpages, leading to user frustration. Another potential problem is that options are added to a command or removed from a command and are not documented, or the values provided to use an option change.

Besides the manpages, parser code and usage text also need to be created for command codes. As the term is employed herein, parser code represents a piece of code that interprets the command, including the options thereof, to allow the program to execute the command appropriately. Usage text is human readable text that is provided by the command that explains how the command may be used, e.g., what the options and parameters associated with a command are.

As with the case with manpages, the prior art processes for creating and updating parser code and usage text also tend to be manual and error-prone. FIG. 3 is a prior art flow diagram illustrating the prior art process for creating and updating the parser code, usage text, and manpages from the command code. The flow diagram begins with development engineer 300 creating command code 302, creating parser code 304, and creating usage text 306. After the command code is created (302), the flow diagram follows arrow 308 to the learning product engineer (310), who creates/edits the manpages (312) in the manner discussed above.

As is typical, testing needs to be performed on the command code to ensure performance and accuracy. Thus, in block 316, the development engineer 300 tests the command code. If the command code is essentially error free and the performance is acceptable, testing is complete with decision block 318, and the command code and manpage are shipped in block 314.

If the testing in block 316 indicates that the command code is unsatisfactory, the development engineer 300 modifies the command code in block 318. If the command code is modified, the parser may also be modified in block 320. The development engineer 300 decides, often subjectively, in block 322 whether the changes to the command code and/or the parser code require a change to the document. If the development engineer decides that a change to the document is needed, the usage text is modified in block 326. On the other hand, if the development engineer assessment is incorrect and the change is not reflected in the usage text, the usage text would be unsynchronized with the changed command codes as a result.

Even if the usage text has been changed (as decided in block 322 and performed in block 326), the development engineer has the discretion to decide, in block 324, whether the changes need to be communicated to the learning products engineer to reflect the changes in the manpages. Again, this decision is often subjective. If the development engineer is incorrect in his assessment or neglects to communicate the changes to the learning products engineer, the manpages would be unsynchronized with the updated command code.

As can be appreciated from FIG. 3, parser code and usage text are manually built and maintained independently. It is thus possible, as can be seen in FIG. 3, to make changes to the parser code without changing the usage text and/or the manpages. Further, it is possible to make changes to usage text without changing the parser code and/or the manpages.

In view of the foregoing, new techniques for creating and updating manpages and/or usage text and/or parser code are desirable.

### SUMMARY OF THE INVENTION

The invention relates, in one embodiment, to a method for generating supporting documents for command code in a command line oriented operating environment. The method includes creating an XML source file, the XML source file includes information required for generating parser code. The parser code facilitates compiling the command code. The method further includes generating at least two of a man page file, a usage message file, and the parser code from the XML source file.

In another embodiment, the invention relates to an article of manufacture comprising a program storage medium having computer readable code embodied therein, the computer readable code being configured for generating supporting documents for command code in a command line oriented operating environment. There is included computer readable code for accessing an XML source file. The XML source file includes information required for generating parser code. The parser code facilitates compiling the command code. There is further included computer readable code for generating at least two of a man page file, a usage message file, and the parser code from the XML source file.

In yet another embodiment, the invention relates a computer-implemented method for generating supporting documents for command code in a command line oriented operating environment. The method includes accessing an XML source file, the XML source file including information required for generating parser code. The parser code facilitates compiling the command code. The method further includes generating a man page file, including reordering the order in which information is furnished in the XML source file and performing one of a XSLT (extensible Stylesheet Language Transformation) transform on the XML source file and a NROFF transform on the XML source file.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a prior art flow diagram illustrating the process for creating commands and associated manpages.

FIG. 2 illustrates a prior art example of how inconsistency between the released code and the manpage can arise for a product.

FIG. 3 is a prior art flow diagram illustrating the prior art process for creating and updating the parser code, usage text, and manpages from the command code.

FIG. 4 shows, in accordance with one embodiment of the present invention, a block diagram illustrating the use of a single XML manpage source file to synchronously generate the supporting files such as manpages, usage message files, parser code files.

FIG. 5 is an exemplary diagram illustrating, in accordance with one embodiment of the present invention, the transformation and reordering of information from the XML manpage source file to automatically create a manpage.

FIG. 6 illustrates, in accordance with one embodiment of the present invention, a parser transform of an exemplary command from an XML manpage source file.

FIG. 7A shows, in accordance with one embodiment of the present invention, run time generation of the usage text.

FIG. 7B shows, in accordance with one embodiment of the present invention, a compile time generation of the usage text.

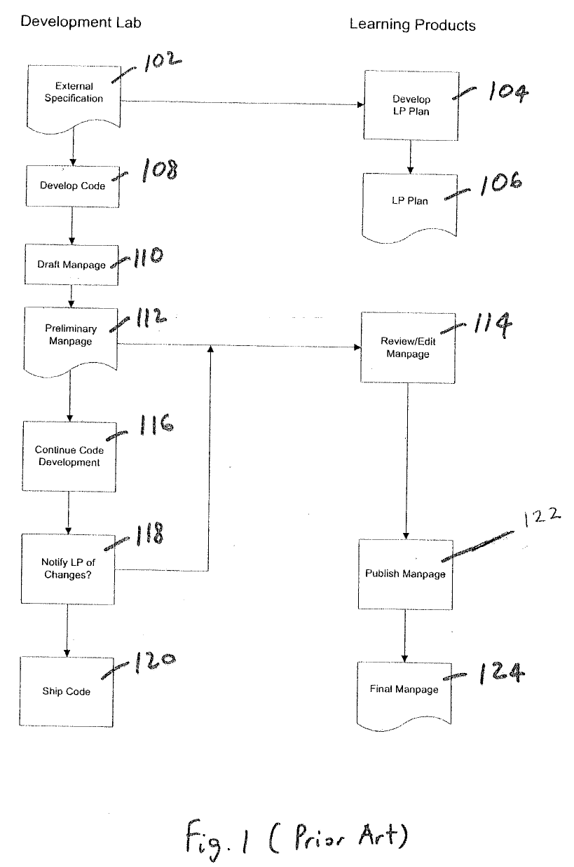

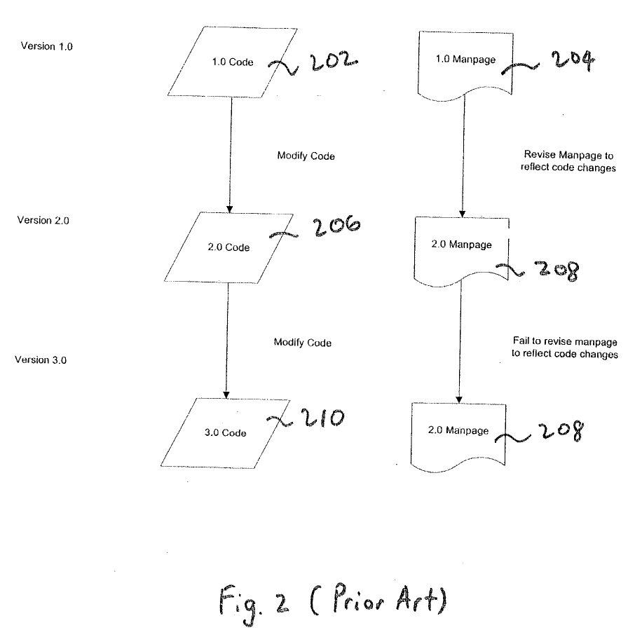

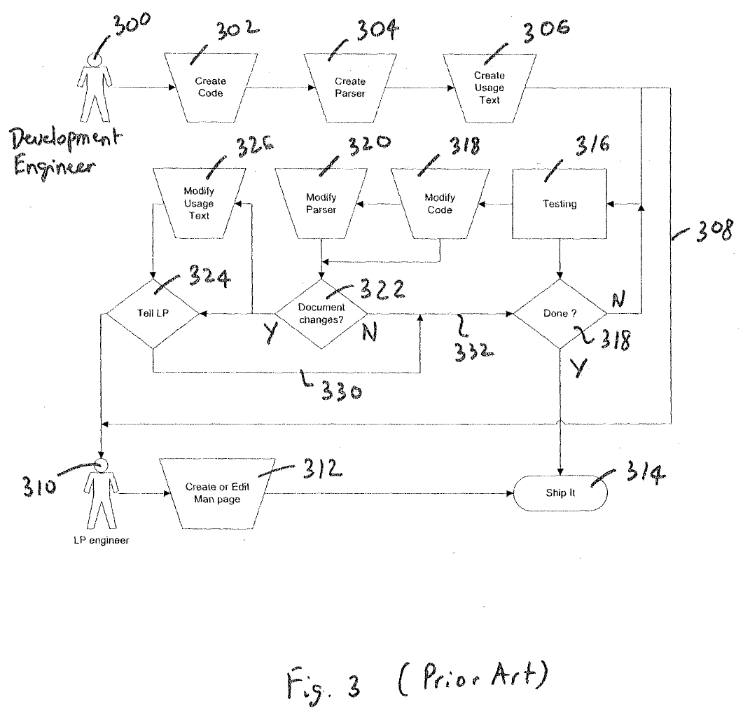

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In one embodiment, the present invention employs a single XML source file from which supporting files such as manpages, usage data files, parser code files, and the like, are automatically generated. Since the needed supporting files (e.g., manpages, usage data files, and parser code files) are automatically generated from a single source, inconsistencies attributable to human judgment and discretion in the creation and updating of the supporting files are substantially reduced. Furthermore, since the supporting files are generated automatically from a single source file, the individual support files are automatically synchronized to the single XML source file, essentially eliminating the possibility that individual support files are not synchronized with one another. Additionally, since all support files derive their information from the single XML source file, the task of updating the support files is advantageously reduced down to updating the single XML source file and regenerating a new set of support files.

In one embodiment, the XML source file describes the syntax of the commands, the usage data, and any other information that would normally be contained in the manpages. Further, since the XML source file contains the information necessary to generate the parser code, the XML source file is thus created even before the command code (i.e., the code that the manpages describe) is even compiled. This requirement, therefore, ensures that the information in the XML source file is always in synchronization with the command code.

The use of XML also offers other advantages. For example, by using XML, engineers are able to employ modem document verification technologies such as document type definition (DTD) and/or XML Schemas to drive syntax directed editors in order to render the task of creating the supporting files (via the XML source file) more efficient and accurate. Take the manpage case, for example. In contrast with the prior art approach in which one has to create manpages using the difficult-to-master NROFF language, the invention allows manpages to be automatically generated from an XML source file. Not only is XML easier to work with, the use of XML also enables robust editing and error checking during the data entry phase. For example, the syntax directed editor working with XML can automatically list elements for entry so a manpage creator does not have to remember the elements. As another example, DTD technology enables the manpage creator to eliminate and/or catch errors while the XML source file is created. In contrast, the NROFF approach of the prior art requires the engineer to execute the NROFF file and view the result on a display in order to validate the NROFF file.

Furthermore, the use of XML technology and appropriate transformations thereon ensure consistency with the presentation of the manpages. Rather than relying on the manpage creator to appropriately order the manpage information, as was done in the prior art, a transform engine analyzes the information furnished in the XML source file and outputs the information to the manpages in the correct order irrespective of the order in which the information is furnished in the XML source file.

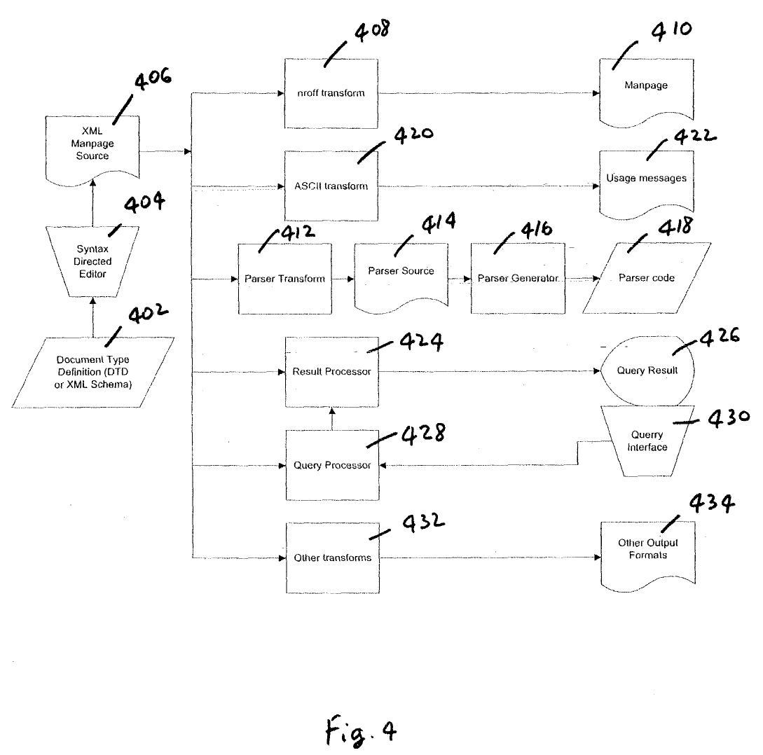

The features and advantages of the present invention may be better understood with reference to the drawings and discussions that follow. FIG. 4 shows, in accordance with one embodiment of the present invention, a block diagram illustrating the use of a single XML manpage source file to synchronously generate the supporting files such as manpages, usage message files, parser code files, and the like. As stated earlier, the XML manpage source conforms to modern document verification technologies such as document type definition (DTD) or XML schema. The DTD or XML schema is furnished in block 402. Block 404 depicts a syntax directed editor that may be employed by the engineer to construct an XML manpage source file. As mentioned, the use of XML facilitates the use of a syntax directed editor (such as EMACS, an open source editor on HP-UX™ and LINUX and XML Spy by Altova GmbH of Rudolfsplatz 13a/9 A-1010 Wien Austria/EU. www.altova.com, on Windows, or another suitable syntax directed editor), which greatly improves the degree of accuracy and efficiency with which the XML source file is created.

The XML manpage source file is shown in block 406. Generally speaking, the XML manpage source file is updated anytime the command code is updated. This is ensured since, as mentioned earlier, the XML manpage source file contains the information necessary to create the parser, which is required for compiling the source code. From this single XML manpage source file 406, a plurality of supporting files may be automatically generated.

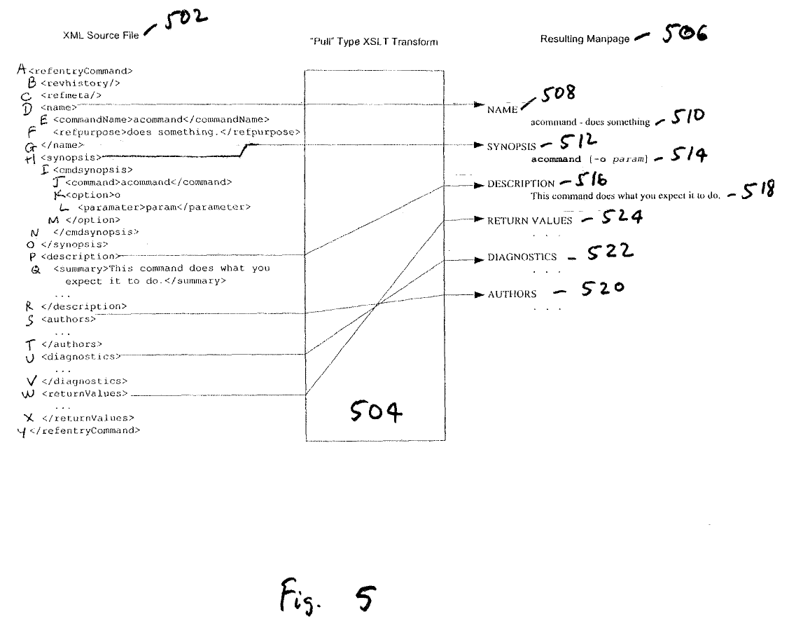

In order to create a manpage from the XML manpage source code 406, an NROFF transform 408 is performed to create an NROFF manpage 410. Currently, to be compatible with existing systems, the NROFF manpage 410 is used as the input to the man command. However, it is conceivable that manpages can be generated directly from the XML manpage source file 406 without resorting to the intermediate NROFF transform 408 and NROFF manpage 410. Note that even with NROFF transform block 408 and NROFF manpage block 410, manpage creators do not have to work in the NROFF domain in order to create manpages. It is possible to perform the XSLT transform directly on the XML manpage source file 406 to obtain manpages. The process for manpage creation is discussed further in connection with FIG. 5 herein.

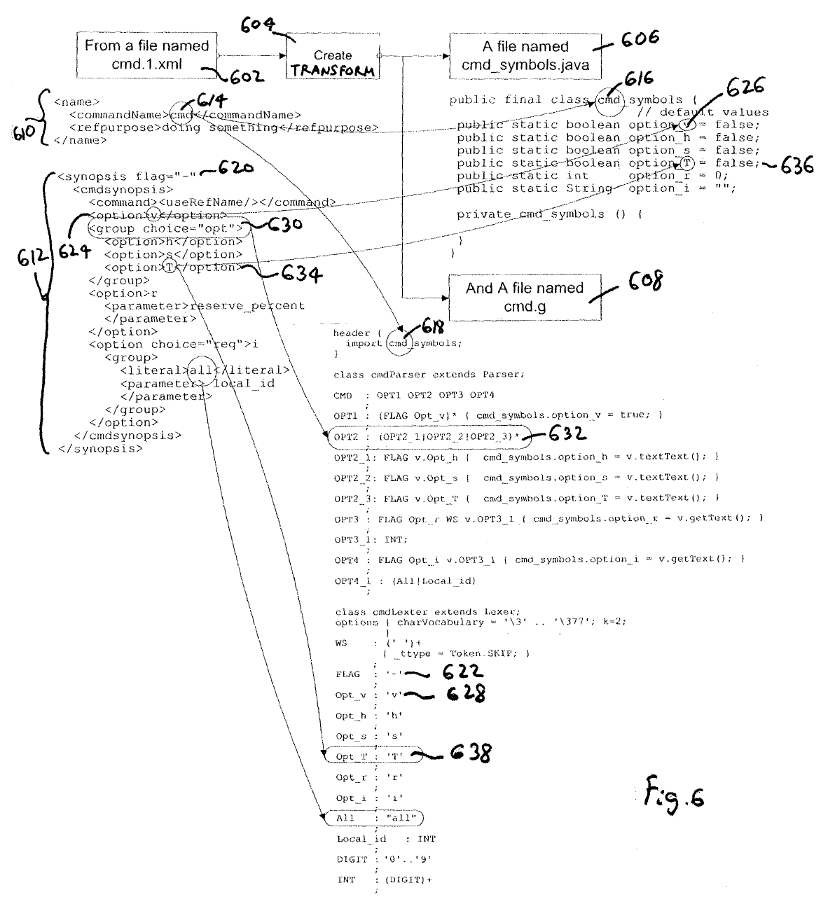

To generate parser code, the XML manpage source code 406 provides an input to parser transform 412. The parser transform 412 creates a parser source 414 from the XML manpage source code 406. The parser source 414 is inputted to a parser generator 416 that generates parser code 418. Further details of the parser transform are discussed with reference to FIG. 6 herein.

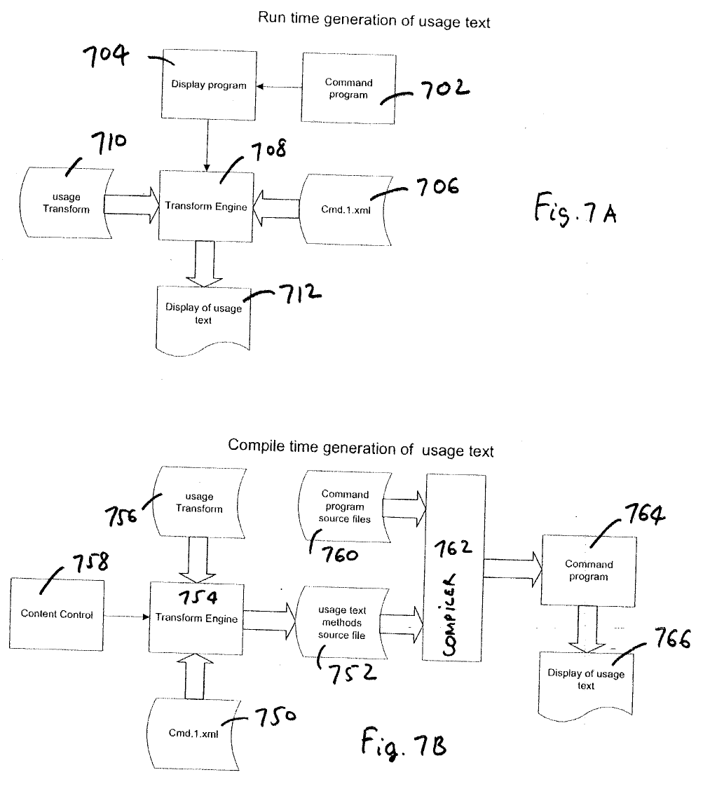

To generate usage messages, the XML manpage source code 406 is used as an input to ASCII transform block 420 that generates usage messages 422 when invoked by a command program. Usage messages can be generated either at run time or at compile time. Further details of the usage message generation are discussed with reference to FIGS. 7A and 7B.

As can be appreciated from the foregoing, the XML manpage source code 406 affords the benefit of working from a single source for the generation of different types of outputs, some of which are intended to be read by humans (such as usage messages 422) and some of which are intended to be machine readable only (such as parser code 418). Via the transformation processes, the supporting files are automatically generated from this single source, thereby virtually eliminating the possibility that the supporting files may be unsynchronized relative to one another. The automatic generation also saves on manual labor, and removes human errors as a potential issue in the generation of the supporting files from the XML manpage source file.

Furthermore, the XML manpage source code 406 can be applied to other transforms 432 to produce other output formats 434. For example, in accordance to one embodiment of the present invention, the other transforms 432 may include a transform of the information in the XML manpage source code into SGML DocBook to produce output for use in Framemaker. Framemaker, available from Adobe Inc. of San Jose, Calif., is a popular editing and desktop publishing software product can import data in DocBook format. As is well known, DocBook is an industry standard for marking up documents. Information on DocBook is available from OASIS—the Organization for the Advancement of Structured Information Standards, at http://www.oasis-open.org. The Framemaker-formatted manpages may then be manipulated in Framemaker, and integrated into other printed (or PDF) documents shipped along with the code. Importing the SGML DocBook transform of the XML manpages source into Framemaker makes it possible to have the content of the manpage in other documents without having to copy it or retype it. Accordingly, changes made near the end of the code development cycle are more likely to be reflected in other published documents.

The XML format also facilitates other types of operation. For example, referring to result processor 424, query result 426, query processor 428, and query interface 430, a query interface can be designed that takes advantage of the structured XML manpage source code 406. For example, a query may be issued to request the display of all examples provided for commands that are security commands; the query result 426 would return only the examples section of manpages that are security commands rather than presenting the entire manpage for each security command. The query example is only illustrative of the flexibility of XML and is not meant to be limiting of the range of applications possible. As a further example, the structure of XML files makes it possible to sub-divide the output documents, if desired.

FIG. 5 is an exemplary diagram illustrating, in accordance with one embodiment of the present invention, the transformation and reordering of information from the XML manpage source file 502 to automatically create a manpage 506. An exemplary section of an XML Manpage Source code 502 is shown with a plurality of source entries labeled A-Y. In practice, there may be many more source entries for describing a given command than shown in exemplary FIG. 5.

According to an embodiment of the present invention, transform engine 504 is a “Pull” Type XSLT (Extensible Stylesheet Language Transform) Transform as opposed to “push” type transforms. XSLT is a standard programming language intended for describing document transformation that conforms to the W3C (World Wide Web Consortium) recommendation. The W3C recommendation itself is available at http://www.w3.org/TR/1999/REC-xslt-19991116.html (as of April, 2003). The “pull” type transform automatically reorders any data that is not in a prescribed order. The “push” type transform, on the other hand, takes the data and places it in the same order that the data was presented. By using a “pull” type transform, the ordering of elements in the output file of the transform engine is advantageously independent of the ordering of elements in the input file. Accordingly, inconsistencies with regard to the ordering of information that may be present in the XML manpage source file do not impact the order with which the information is presented in the output manpage 506.

With reference to FIG. 5, source entry D <name> of the XML Manpage Source code 502 is transformed directly to NAME entry on the Resulting Manpage 506. Source entry E and source entry F transform to “acommand—does something” 510. Source entry H <synopsis> of the XML Source code 502 transforms to SYNOPSIS 512 on the Resulting Manpage 512. Source entries H through O of the XML Manpage Source code 502 transforms to “acommand [-o param]” on the Resulting Manpage 506. Source entry P <description> of the XML Manpage Source code 502 transforms to DESCRIPTION 516 on the Resulting Manpage 506. Source entries Q <summary>This command does what you expect it to do./summary> transforms to “This command does what you expect it to do” 518 on the Resulting Manpage 506.

Source entries S-T <authors> of the XML Manpage Source code 502 transforms to “AUTHORS . . . ” 520 on the Resulting Manpage 506. Source entries U-V <diagnostics> of the XML Manpage Source code 502 transforms to “DIAGNOSTICS . . . ” 522 on the Resulting Manpage 506. Source entries W-X <returnValues> of the XML Manpage Source code 502 transforms to “RETURN VALUES . . . ” 524 on the Resulting Manpage 506.

It should be noted that although the source entries S-T <AUTHORS> in the XML Manpage Source code 502 occurs before the source entries W-X <RETURNVALUES>, the “Pull” Type XLST Transform 504 simply reorders the information obtained in the source entries so the Resulting Manpage 506 is in a prescribed <RETURN VALUES> occurs before <AUTHORS> in the output Resulting Manpage 506.

As can be appreciated from the foregoing, the invention allows the information to be presented in a consistent order in the output resulting manpage irrespective of the order in which the information is arranged in the XML source file. Accordingly, information is presented to the user in a consistent order and format, substantially rendering the resulting manpage more user-friendly.

As stated earlier, it is possible, as shown in FIG. 5, to perform the transformation without resorting to the intermediary of the NROFF format. However, NROFF transformation may also be undertaken for backward compatibility reasons, if such is desired. In FIG. 5, transformation engine 504 may output a NROFF file, which may then be executed to generate the resulting manpage 506.

As discussed, the same XML Manpage Source code is also used to generate the parser code. FIG. 6 illustrates a parser transform 604 of an exemplary command from an XML manpage source file cmd.1.xml 602. In one embodiment, a Xalan transform engine 604 is used to create a file cmd_symbols.java 606 and a file cmd.g 608 from the XML manpage source file. These files are then inputted into a parser generator, such as ANTLR, to generate the desired parser code. Xalan is an open source XSLT transform engine available from http://xml.apache.org (as of April, 2003). ANTLR is a public domain parser generator, which is available from www.antlr.org (as of April, 2003).

A partial listing of the XML source file cmd.1.xml (602) is shown on the left side of FIG. 6, under the block representing cmd.1.xml (602). Similarly, a partial listing of the file cmd_symbols.java (606) is shown in the upper right hand section of FIG. 6, under the block representing cmd_symbols.java (606). The file cmd_symbols.java (606) may be thought of as the interface between the parser and the rest of the code. FIG. 6 also shows a partial listing of the file cmd.g (608) in the lower right hand section of FIG. 6, under the block representing cmd.g (608). File cmd.g (608) may be thought of as the parser input code file, which is inputted into a parser generator to generate the parser code.

The listing for the XML source file cmd.1.xml (602) comprises two main sections: a command name section 610, and a synopsis section 612. Generally speaking, the command name section 610 defines the name of the command, and the synopsis section 612 defines, among others, the available options and parameters for the command of section 610.

Based on the command name section 610, the transform engine 604 extracts the command name from the XML source file cmd.1.xml (602). For example, the name cmd (614) is extracted from the command name section 610 of the XML source file cmd.1.xml (602), and is placed into the variable cmd (616) of the file cmd_symbols.java 606. Similarly, the name cmd (614) is extracted from the command name section 610 of the XML source file cmd.1.xml (602) and placed into the variable cmd (618) of the file cmd.g (608). Thus, the name of the command contained in the XML manpage source file can be extracted to build the files cmd_symbols.java 606 and cmd.g 608.

The synopsis section 612 includes sufficient information to generate the interface file cmd_symbols.java (606) and the parser input code file cmd.g (608). The following examples are illustrative of this fact. Referring to the synopsis section 612, the expression “synopsis flag=”−“” (620) of the XML source file cmd.1.xml (602) is transformed to “Flag: ‘−’” (622) of the file cmd.g 608. The expression “<option>v</option>” (624) of the XML source file cmd.1.xml (602) is extracted and employed in the expression “public static Boolean option_v=false;” (626) within the file cmd_symbols.java 606. The same expression “<option>v</option>” (624) of the XML source file cmd.1.xml (602) is also extracted and employed in the expression “Opt_v: ‘v’” (628) of the parser input code file cmd.g (608).

Given different types of option grouping, for example, the expression “<group choice=”opt“>” (630) of the XML source file cmd.1.xml (602) transforms into the expression “OPT2: (OPT2_1|OPT2_2|OPT2_3)*” (632) of the parser input code file cmd.g (608). One of the elements under the expression “<group choice-“opt”>” (630) of the XML source file cmd.1.xml (602) is shown in FIG. 6 to be the expression “<option>T</option” (634). The value of T of the expression “<option>T</option” (634) is extracted and employed in the expression “public static Boolean option_T =false;” (636) of the file cmd_symbols java (606) and also in the expression “Opt_T: ‘T’” (638) of the parser input code file cmd.g (608).

Note that the above examples are only some of the transforms that take place in order to derive the parser interface file (606) and the parser input code file (608). Although Xalan is employed as the transform engine in this case, the invention is not limited to any particular transform engine. Likewise, although it is contemplated that the ANTLR parser generator may be employed to generate the parser code from the parser code input file (608), the invention is not limited to any particular parser generator. Given this disclosure, one skilled in the art will readily appreciate that other transform engines and/or parser generators may be adapted to generate the parser code from the XML input source file.

As mentioned, the usage text may also be obtained from the information contained in the XML Manpage Source code. FIGS. 7A and 7B are diagrams illustrating two exemplary approaches for generating usage text in accordance to an embodiment of the present invention. FIG. 7A shows run time generation of the usage text and FIG. 7B shows a compile time generation of the usage text.

Referring to FIG. 7A, a Command Program 702 executes an optional Display Program 704 to invoke a Transform Engine 708. Display Program 704, which is optional, provides additional flexibility to control the amount information provided to the Display of usage text 712. Command program 702 describes to transform engine 708 the transform(s) to be performed. Transform engine 708 also takes as inputs Usage Transform 710 and the XML source code file Cmd.1.xml (706). The Usage Transform 710 contains, for example, a description of usage information to be extracted from Cmd.1.xml 706. Usage transform 710 may be implemented using, for example, XSLT technology.

Different elements of the XML source code file Cmd.1.xml 706 may be displayed in response to the Display Program 704. For example, the Display Program 704 can be programmed to display the synopsis, examples of command usage, or the usage text.

Referring to FIG. 7B, the generation of the usage text is performed primarily at compile time. This may be useful in cases, for example, where the XML source file is unavailable at execution time. The XML source file cmd.1.xml 750 may be transformed via a transform engine 754 to produce a usage text methods source file 752, in response the XSLT usage transform file 756 and content control file 758. Content control file 758 performs a similar function to the display program 704 of FIG. 7A.

A java or C compiler 762 combines the usage text methods source file 752 and the Command program source files 760 to create a Command program 764. The Command program 764 may then be executed at execution time to produce a display of usage text 766. The execution may take place, for example, when a help function is invoked. For example, a command followed by a “-h” option may invoke the display of usage text 766 to be displayed on a screen.

As can be appreciated from the foregoing, the present invention addresses many issues that have plagued the development of manpages and other supporting files. For any given iteration of the command code, the supporting files may now be generated automatically and from the same XML source file. Since the supporting files such as manpages, parser code, and usage text are all automatically created from the XML source file, the problem with lack of synchronicity among these supporting files is substantially eliminated. Furthermore, since the supporting files can be automatically generated from a single source file, significant savings in labor and time, as well as a significant reduction in the frequency of human-induced errors, can be realized.

Furthermore, since the XML source file contains the information necessary to generate the parser code, the XML source file is now created even before the command code can be compiled. This requirement ensures that the XML source file is timely updated for any given iteration of the command code. Accordingly, the problem associated with the lack of synchronicity between the supporting files (which are now automatically derived from the XML source file) and the command code is also substantially eliminated.

The use of XML and its structured data description facilities also offers many advantages. Whereas NROFF is a limited and rigid language, XML has many different applications and is a widely used technology, rendering the task of documenting in XML less burdensome for engineers. As mentioned, XML (or similar technologies) allows the engineer to perform data checking and error checking in a highly efficient and accurate way by employing technologies such as DTD.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for generating supporting documents for command code in a command line oriented operating environment, including:
creating an XML source file, said XML source file including information required for generating parser code, said parser code facilitating compiling said command code; and
generating at least two of a man page file, a usage message file, and said parser code from said XML source file.

2. The method of claim 1 wherein said creating said XML source file includes employing a syntax directed editor.

3. The method of claim 1 wherein said creating said XML source file includes employing document type definition for verification.

4. The method of claim 1 wherein said creating said XML source file includes employing XML schema for verification.

5. The method of claim 1 wherein said XML source file is employed for generating said man page file, said generating said man page file includes reordering the order in which information is furnished in said XML source file.

6. The method of claim 5 wherein said generating said man page file includes performing XSLT (eXtensible Stylesheet Language Transformation) transform on said XML source file.

7. The method of claim 5 wherein said generating said man page file includes performing nroff transform on said XML source file.

8. The method of claim 1 wherein said XML source file is employed for generating said parser code, said generating said parser code includes performing a parser transform on said XML source file to generate parser source, said generating said parser code further includes employing a parser generator to generate said parser code from said parser source.

9. The method of claim 1 wherein said XML source file is employed for generating said usage message file, said generating said usage message file includes performing an ASCII transform on said XML source file.

10. The method of claim 1 wherein said XML source file is employed for generating said man page file, said usage message file, and said parser code from said XML source file.

11. An article of manufacture comprising a program storage medium having computer readable code embodied therein, said computer readable code being configured for generating supporting documents for command code in a command line oriented operating environment, comprising:
computer readable code for accessing an XML source file, said XML source file including information required for generating parser code, said parser code facilitating compiling said command code; and
computer readable code for generating at least two of a man page file, a usage message file, and said parser code from said XML source file.

12. The article of manufacture of claim 11 wherein said computer readable code for generating at least two of a man page file, a usage message file, and said parser code includes computer readable code for generating said man page file, said computer readable code for generating said man page file includes computer readable code for reordering the order in which information is furnished in said XML source file.

13. The article of manufacture of claim 12 wherein said computer readable code for generating said man page file includes computer readable code for performing XSLT (extensible Stylesheet Language Transformation) transform on said XML source file.

14. The article of manufacture of claim 12 wherein said computer readable code for generating said man page file includes computer readable code for performing nroff transform on said XML source file.

15. The article of manufacture of claim 11 wherein said computer readable code for generating at least two of a man page file, a usage message file, and said parser code includes computer readable code for generating said parser code, said computer readable code for generating said parser code includes computer readable code for performing a parser transform on said XML source file to generate parser source, said computer readable code for generating said parser code further includes computer readable code for employing a parser generator to generate said parser code from said parser source.

16. The article of manufacture of claim 11 wherein said computer readable code for generating at least two of a man page file, a usage message file, and said parser code includes computer readable code for generating said usage message file, said computer readable code for generating said usage message file includes computer readable code for performing an ASCII transform on said XML source file.

17. The article of manufacture of claim 11 wherein said computer readable code for generating at least two of a man page file, a usage message file, and said parser code includes computer readable code for generating said man page file, said usage message file, and said parser code from said XML source file.

18. A computer-implemented method for generating supporting documents for command code in a command line oriented operating environment, including:
accessing an XML source file, said XML source file including information required for generating parser code, said parser code facilitating compiling said command code; and
generating a man page file, including reordering the order in which information is furnished in said XML source file and performing one of an XSLT (eXtensible Stylesheet Language Transformation) transform on said XML source file and a nroff transform on said XML source file.

19. The computer-implemented method of claim 18 further including generating said parser code from said XML source file, said generating said parser code includes performing a parser transform on said XML source file to generate parser source, said generating said parser code further includes employing a parser generator to generate said parser code from said parser source.

20. The computer-implemented method of claim 19 further including generating usage message file from said XML source file, said generating said usage message file includes performing an ASCII transform on said XML source file.

21. The computer-implemented method of claim 18 wherein said creating said XML source file includes employing a syntax directed editor.

22. The computer-implemented method of claim 18 wherein said creating said XML source file includes employing document type definition for verification.

23. The computer-implemented method of claim 18 wherein said creating said XML source file includes employing XML schema for verification.
